(19) United States
(12) Patent Application Publication
(10) Pub. No.: US 2006/0230399 A1
(43) Pub. Date: Oct. 12, 2006

(54) Remote scriptlet execution

(75) Inventors: Igor Fedorenko, Noth York (CA); Paul-Vlad Tatavu, North York (CA); Andrew Niel Trossman, North York (CA)

Correspondence Address: IBM CORP (YA);C/O YEE & ASSOCIATES PC, P.O. BOX 802333, DALLAS, TX, 75380, US

(73) Assignee: International Business Machines Corporation, Armonk, NY (US)

(21) Appl. No.: 11/104,328

(22) Filed: Apr. 12, 2005

(51) Int. Cl. G06F 9/445

(52) U.S. Cl. 717/175

(57) ABSTRACT

Remote execution of management scriptlets on a plurality data processing systems in a data center. The management scriptlets may be written in many different languages using a variety of network communication protocols and operating systems. First, a data processing system to be managed is accessed with a login command using network protocol and credentials determined prior to login. Next, the management scriptlet is executed remotely regardless of the communication protocol and credentials selected. Finally, scriptlet output is captured and a logout command exits the data processing system.

### BACKGROUND OF THE INVENTION

1. Technical Field

The present invention relates generally to an improved data processing system, and in particular to a method and apparatus for processing data. Still more particularly, the invention relates to a method, apparatus, and computer instructions for performing remote scriptlet execution.

2. Description of Related Art

A system manager of a data center often faces the daunting challenge of managing a great number of computers in the data center. Workflows to manage data centers often require execution of management programs on many different computers from a single management console. Often, system managers combine low-level system management commands using scripting languages like PERL or VBScript to write management scriptlets. Thus, management scriptlets allow system managers to achieve higher-level management goals.

In order to manage many computers from a single workstation, special management agents deployed on all managed data processing systems allow scripts to be executed. However, deployment of management agents significantly complicates the task of managing the data center because the management agents are deployed locally. Thus, it would be advantageous to have an improved method, apparatus, and computer instructions for simplifying the task of managing data centers.

### SUMMARY OF THE INVENTION

The present invention provides for a method, apparatus, and computer instructions for remotely executing a program. A connection is established between a management data processing system and a remote data processing system. A communication protocol is selected from a plurality of communication protocols in order to establish communication between the data processing systems. The remote data processing system is logged into from the management data processing system and a program language interpreter is started. The program is executed on the management data processing system regardless of the communication protocol selected. The output of the program is captured and the output is delivered to a management application.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a network of data processing systems in which the present invention may be implemented.

FIG. 2 is a block diagram of a data processing system that may be implemented as a server in which the present invention may be implemented.

FIG. 3 is a block diagram illustrating a data processing system in which the present invention may be implemented.

FIG. 4 is a block diagram illustrating remote scriptlet execution vis-à-vis a data center model object, in accordance with a preferred embodiment of the present invention.

FIG. 5 is a block diagram illustrating an example of remote scriptlet execution on a remote data processing system from a management data processing system via an instance of a service access point, in accordance with a preferred embodiment of the present invention.

FIG. 6 is a flowchart illustrating a method of performing remote scriptlet execution, in accordance with a preferred embodiment of the present invention.

### DETAILED DESCRIPTION OF THE PREFERRED EMBODIMENT

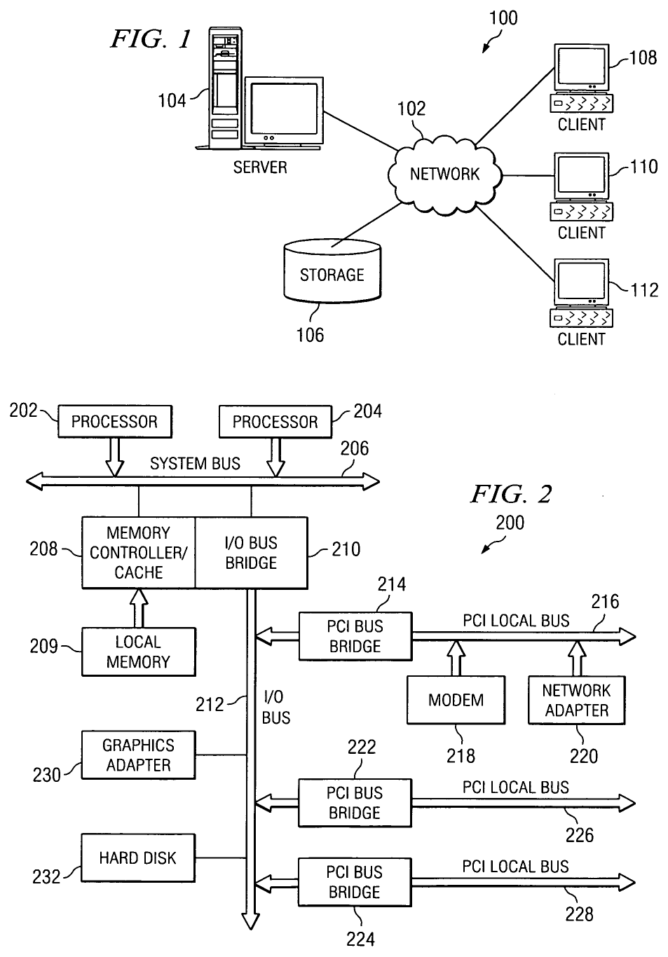

FIG. 1 is a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, running system images, and programs to clients 108-112. Clients 108, 110, and 112 are clients to server 104. Network data processing system 100 may include additional servers, clients, and other devices not shown. In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

FIG. 2 is a block diagram of a data processing system that may be implemented as a server, such as server 104 in FIG. 1, in which the present invention may be implemented. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O Bus Bridge 210 is connected to system bus 206 and provides an interface to I/O bus 212. Memory controller/cache 208 and I/O Bus Bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in connectors.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM eServer pSeries system, a product of International Business Machines Corporation in Armonk, N.Y., running the Advanced Interactive Executive (AIX) running system or LINUX running system.

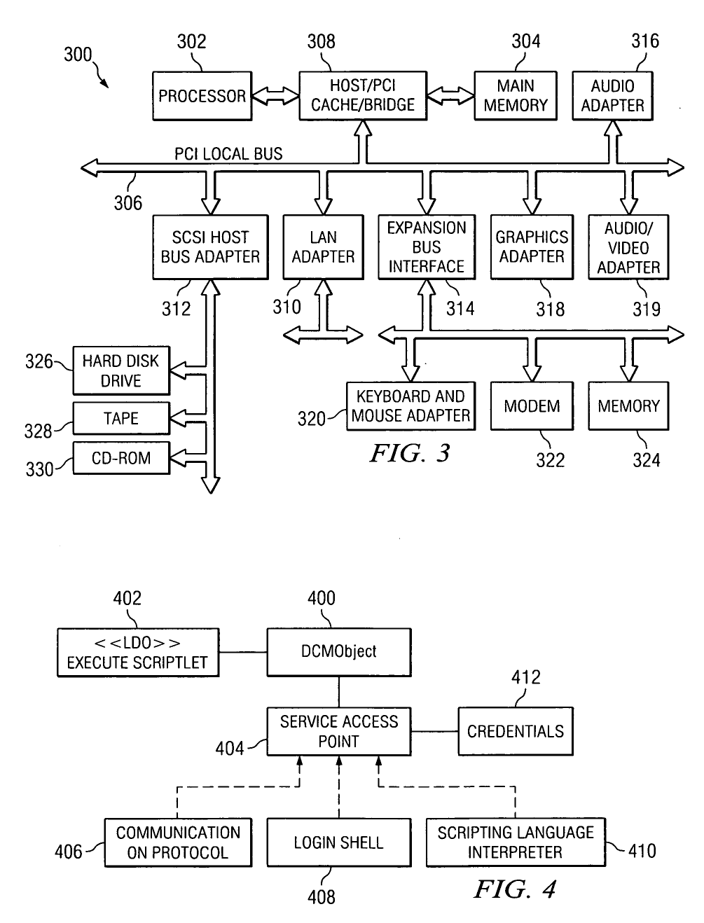

FIG. 3 is a block diagram illustrating a data processing system in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI Bridge 308. PCI Bridge 308 also may include an integrated memory controller and cache memory for processor 302. Additional connections to PCI local bus 306 may be made through direct component interconnection or through add-in boards. In the depicted example, local area network (LAN) adapter 310, small computer system interface (SCSI) host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. SCSI host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The running system may be a commercially available running system, such as Windows XP, which is available from Microsoft Corporation. An object oriented programming system such as Java may run in conjunction with the running system and provide calls to the running system from Java programs or programs executing on data processing system 300. “Java” is a trademark of Sun Microsystems, Inc. Instructions for the running system, the object-oriented programming system, and programs or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash read-only memory (ROM), equivalent nonvolatile memory, or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interfaces As a further example, data processing system 300 may be a personal digital assistant (PDA) device, which is configured with ROM and/or flash ROM in order to provide non-volatile memory for storing running system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

The present invention provides for a method, apparatus, and computer instructions for remotely executing a program. A connection is established between a management data processing system and a remote data processing system. A communication protocol is selected from a plurality of communication protocols in order to establish communication between the data processing systems. The remote data processing system is logged into from the management data processing system and a program language interpreter is started. The program is executed on the management data processing system regardless of the communication protocol selected. The output of the program is captured and the output is delivered to a management application.

FIG. 4 is a block diagram illustrating remote scriptlet execution vis-à-vis data center model (DCM) object 400, in accordance with a preferred embodiment of the present invention. Data center model object 400 represents a physical device, and may be a server in a data center, a client data processor system, a router, or any other hardware or software in a data center. Thus, data center model object 400 may represent a data processing system, such as server 104 or clients 108, 110, and 112 in FIG. 1, server 200 in FIG. 2, or client 300 in FIG. 3, depending on the implementation of the invention. Data center model object 400 may represent multiple data processing systems, such as a server cluster. Thus, although scripts are executed on physical data processing systems, data center model object 400 may be used to model how scripts are executed on physical data processing systems.

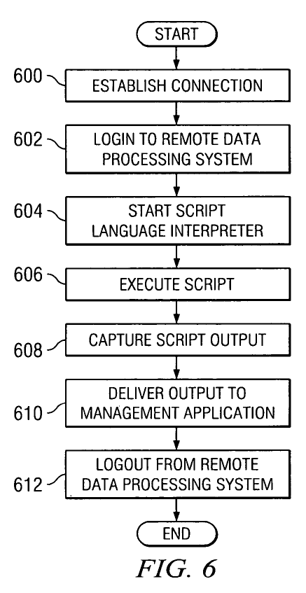

To perform remote scriptlet execution, a particular scriptlet execution logical device operation 402 is determined by association with data center model object 400. Logical device operation 402 may define that remote execution will be driven by an EXPECT script in an illustrative example, though any suitable scripting language may be used. Then, service access point 404 associated with data center model object 400 is determined using a matching algorithm. Service access point 404 is the interface between a management data processing system and a remote data processing system. Thereafter, the implementation of logical device operation 402 constructs an EXPECT script by calling corresponding methods of service access point 404. Each of the methods contributes to the final EXPECT script, which may have a logical structure shown in FIG. 6. The dynamically generated EXPECT script facilitates execution of various existing programs, such as TELNET or PERL.

Logical device operation 402 does not define or limit implementation of a communication protocol 406, login shell 408, or scripting language interpreter 410. Instead, communication protocol 406, login shell 408, and scripting language interpreter 410 are determined by an instance of service access point 404 associated with data center model object 400.

Furthermore, different credentials 412 may be used by associating different service access points with data center model object 400. Likewise, different communication protocols and login shells may be supported by using different service access points. Some service access points can support multiple scripting languages.

Because service access point 404 credentials 412 are not defined or limited by the logical device operation, the communication protocol and credentials used to connect data processing systems may be selected from any number of available communication protocols and credentials used in the data center. Thus, the mechanism of the present invention allows execution of programs on remote data processing systems regardless of the communication protocol or credentials used to establish communication between data processing systems. The program language interpreter and/or the service access point allow the program to be remotely executed in this manner.

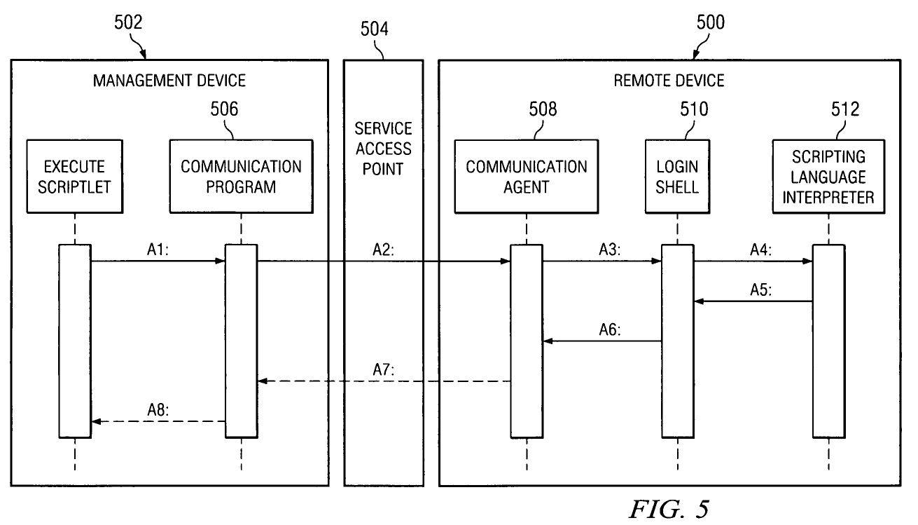

FIG. 5 is a block diagram illustrating an example of remote scriptlet execution on remote data processing system 500 from management data processing system 502 via an instance of service access point 504, in accordance with a preferred embodiment of the present invention. Remote data processing system 500 and management data processing system 502 may be servers or clients, such as server 104 or clients 108, 110, and 112 in FIG. 1, server 200 in FIG. 2, or client 300 in FIG. 3.

Remote scriptlet execution may be performed regardless of communication protocols and credentials selected as follows. First, management data processing system 502 establishes a connection with remote data processing system 504 via message A1, which is transmitted by communication program 506. Interaction between communication program 506 and communication agent 508 takes place via message A2, though message A2 is hidden by communication infrastructure and is not performed explicitly. Message A2 is transmitted over a network, such as network 102 of FIG. 1.

Next, management data processing system 502 logs into remote data processing system 500 via message A3 transmitted to login shell 510. Scripting language interpreter 512 is then started and the script is executed via message A4. In other illustrative embodiments, scripting language interpreter may be any program language interpreter. The program is executed on remote data processing system 500, though the command to perform the execution is initiated in management data processing system 502.

After execution of the script, script output is captured and delivered back to a management application via message A5. Subsequently, management data processing system 502 logs out of remote data processing system 500 via message A6. Another interaction between communication program 506 and communication agent 508 takes place via message A7 to begin disconnecting systems 500 and 502, though message A7 is hidden by communication infrastructure and is not performed explicitly. Message A7 is transmitted over a network, such as network 102 of FIG. 1. Finally, management data processing system 502 disconnects from remote data processing system 500 via message A8.

FIG. 6 is a flowchart illustrating a method of performing remote scriptlet execution, in accordance with a preferred embodiment of the present invention. The method shown in FIG. 6 may be implemented between servers and clients, such as server 104 or clients 108, 110, and 112 in FIG. 1, server 200 in FIG. 2, or client 300 in FIG. 3. The flowchart shown in FIG. 6 also shows the logical structure of a dynamically executed script, as described in FIG. 4 and FIG. 5.

First, a connection is established between the management data processing system and the remote data processing system (step 600). In an illustrative embodiment, a “script1.pl” PERL script is to be executed on a remote UNIX server “server1” using SSH communication protocol. The credentials are username “user1” and password “secure.” In this case, “server1” is represented as the data center model object. Thus, during the first step, an SSH connection is established between the management data processing system and the remote data processing system.

Next, the management data processing system logs into the remote data processing system (step 602). Continuing the illustrative example, the management data processing system logs into remote UNIX server “server 1” using the credentials “user1” and “secure.”

After login, the script language interpreter is started (step 604). Continuing the illustrative example, a PERL script interpreter is started.

Then, the management device executes the script (step 606). Continuing the illustrative example, the management data processing system initiates a command that causes the remote data processing system to execute “script1.pl” on the remote data processing system.

Optionally, the output of the script is captured after executing the script (step 608). Next, the output of the script is delivered back to the management application or to the logical device operation implementation (step 610). Continuing the illustrative example, the output of “script1.pl” is delivered back to the management application or the logical device operation implementation. For example, the management application may be a master records database and the script is a program that retrieves records from the remote data processing system. Thus, the script is remotely executed, the records on the remote data processing system are captured, and the records are delivered to the master records database.

Finally, the management data processing system logs out of the remote data processing system (step 612). Continuing the illustrative example, the management data processing system logs out of the remote UNIX server. The process terminates thereafter.

Thus, the mechanism of the present invention provides for advantageous remote execution of scriptlets. The mechanism of the present invention greatly reduces the burden of designing management workflows. Workflows that use the mechanism of the present invention will be simpler to develop, as explicitly coding remote execution is not necessary. Furthermore, the same workflow can be executed on a rage of similar data processing systems that use different communication protocols or different login shells.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method of remotely executing a program, the method comprising:
establishing a connection between a first data processing system and a second data processing system;
determining a communication protocol to use to establish communication between the first data processing system and the second data processing system, wherein the communication protocol is selected from a plurality of communication protocols;
logging into the second data processing system from the first data processing system;
starting a program language interpreter; and
executing the program on the second data processing system via a command initiated in the first data processing system, wherein the step of executing the program may occur regardless of the communication protocol selected.

2. The method of claim 1 wherein the program has an output and wherein the method further comprises:
capturing the output; and
delivering the output to a management application.

3. The method of claim 2 further comprising:
logging out of the second data processing system; and
disconnecting the first data processing system and second data processing system.

4. The method of claim 1 wherein the interface between the first data processing system and the second data processing system comprises a service access point.

5. The method of claim 4 wherein implementation of one of the communication protocol, a login shell, the program language interpreter, and combinations thereof are determined by the service access point.

6. The method of claim 4 further comprising:
constructing the program by calling corresponding methods of the service access point.

7. The method of claim 6 wherein the program is an EXPECT script.

8. A computer program product in a computer readable medium, said program designed to carry out the steps of:
establishing a connection between a first data processing system and a second data processing system;
determining a communication protocol to use to establish communication between the first data processing system and the second data processing system, wherein the communication protocol is selected from a plurality of communication protocols;
logging into the second data processing system from the first data processing system;
starting a program language interpreter; and
executing the program on the second data processing system via a command initiated in the first data processing system, wherein the step of executing the program may occur regardless of the communication protocol selected.

9. The computer program product of claim 8 wherein the program has an output and wherein the method further comprises:
capturing the output; and
delivering the output to a management application.

10. The computer program product of claim 9 wherein the program is further designed to carry out the steps of:
logging out of the remote data processing system; and
disconnecting from the remote device.

11. The computer program product of claim 8 wherein the interface between the first data processing system and the second data processing system comprises a service access point.

12. The computer program product of claim 11 wherein implementation of one of the communication protocol, a login shell, the program language interpreter, and combinations thereof are determined by the service access point.

13. The computer program product of claim 11 wherein the computer program is further designed to carry out the step of constructing the program by calling corresponding methods of the service access point.

14. The computer program product of claim 13 wherein the program is an EXPECT script.

15. A data processing system comprising:
a bus;
a memory operably connected to the bus;
a processor operably connected to the bus;
wherein the memory contains instructions to perform the steps of:
establishing a connection between a first data processing system and a second data processing system;
determining a communication protocol to use to establish communication between the first data processing system and the second data processing system, wherein the communication protocol is selected from a plurality of communication protocols;
logging into the second data processing system from the first data processing system;
starting a program language interpreter; and
executing the program on the second data processing system via a command initiated in the first data processing system, wherein the step of executing the program may occur regardless of the communication protocol selected.

16. The data processing system of claim 15, wherein the program has an output and wherein the memory contains additional instructions to perform the steps of:
capturing the output; and
delivering the output to a management application.

17. The data processing system of claim 16, wherein the memory contains additional instructions to perform the steps of:
logging out of the remote data processing system; and
disconnecting from the remote device.

18. The data processing system of claim 15 wherein the interface between the first data processing system and the second data processing system comprises a service access point.

19. The data processing system of claim 18 wherein implementation of one of a communication protocol, a login shell, the program language interpreter, and combinations thereof are determined by the service access point.

20. The data processing system of claim 18 wherein the memory contains additional instructions to perform the step of constructing the program by calling corresponding methods of the service access point.
